(19) United States
(12) Patent Application Publication
(10) Pub. No.: US 2018/0338421 A1
(43) Pub. Date: Nov. 29, 2018

(54) Articulating and Variable Height Vegetation Cutter

(71) Applicant: Larry Wayne Christian, McCalla, AL (US)

(72) Inventor: Larry Wayne Christian, McCalla, AL (US)

(21) Appl. No.: 16/039,846

(22) Filed: Jul. 19, 2018

Related U.S. Application Data
(60) Provisional application No. 62/584,213, filed on Nov. 10, 2017.

(51) Int. Cl. A01D 34/86; A01D 34/80

(52) U.S. Cl. CPC A01D 34/866; A01D 34/80

(57) ABSTRACT

The preferred embodiment of the present invention is generally described as an articulable and raiseable brush cutting implement. Generally, the inventor intends for the articulable and raiseable brush cutting implement to function in association with a hydraulic system. In embodiments, the articulable and raiseable brush cutting implement may interact with material to cut above upon being raised or below upon being lowered by an operator of an attached primary driver 201.

### CROSS-REFERENCE TO RELATED APPLICATIONS

This application claims the benefit of U.S. Provisional Patent Application 62/584,213, filed on Nov. 10, 2017, which is hereby incorporated by reference in its entirety.

### BACKGROUND OF THE INVENTION

The present inventor has recognized a variety of problems associated with limitations of existing primary driver-mounted vegetation clearing systems. Namely, as configured, existing primary driver-mounted vegetation clearing systems perform inadequately when keeping woods roads, ditch banks, and other passageways requiring tall clearance free from protruding limbs, brush, and other vegetation.

Existing vegetation cutters mounted to the front end of a primary driver such as a tractor, skid steer, or all-terrain vehicle often fail to articulate and raise such as to have the ability to cut vegetation that might grow at an position above or horizontal to the primary driver during normal usage. A known problem associated with other mechanisms is associated with the difficulty in raising and maneuvering a rotating bladed deck in a controllable fashion while remaining in the control seat of the primary driver.

Other known devices, including the “Chop-Zilla” by agriquip, incorporate rotatable steel tubing without a protective cutting deck and a rotating circular saw blade on either end. Such mechanisms enable the bar to rotate, however such mechanisms also have the undesirable potential to pose extreme danger to the operator of the machine, or other proximal persons and objects, if the blades impacted an object that the blades are unable to cut.

Moreover, existing vegetation cutters also fail to interact with a standard form universal quick attach plate. Existing vegetation cutting systems, including especially the Lane Shark and the Limb Ninja systems known in the prior art, also require multiple persons to attach apparatuses in preparation for normal usage. In such prior art systems, positioning to different angles requires manual adjustment of the linkage, a task which likely requires more than one person. A need, therefore, remains for a non-manual adjustment system that requires only one person to attach relevant apparatuses in preparation for normal usage. Another problem with such systems is that the front-end loader of a primary driver has to be at or near grade level position to allow one or more persons to manually position the cutter deck. Further, such systems also have limitations with regard to angle positioning, such that the angle adjustments are limited to a discrete set of specific angles. A need, therefore, remains for a cutting system with a cutter deck that can continuously be adjusted to any angle without leaving the seat of the primary driver.

Further, existing vegetation cutting systems known in the prior art are also very heavy. Existing vegetation cutting systems known in the prior art often cannot not be used on smaller utility type primary drivers. Existing vegetation cutting systems known in the prior art generally require some form of counter weight to maintain proper balance when the cutter is extended.

Other solutions are located to the rear of primary drivers, causing difficulty for the operator to rapidly visually assess whether an operation of a cutting mechanism has achieved the desired effect due to a rearward orientation of the cutting mechanism. Moreover, a vegetation cutter mounted to the rear of a primary driver in prior art solutions cannot be raised higher than the three-point hitch of the prime mover, which typically has a height of about one foot, and therefore cannot cut vegetation oriented at a height above the primary driver during normal usage. Other solutions also require the dedication of the primary driver to the cutter device. Moreover, other solutions have exposed components, including hydraulic cylinders and pulley systems, configured in such a way that invites damage to the exposed components especially including the hydraulic cylinder from limbs and other debris during operation.

Further, in known prior art systems, operation requires the operator to leave the seat of the primary driver and position a cutting mechanism manually. Operation of known systems requires the operator of the primary driver to leave the control seat of the primary driver to reposition a cutter deck manually prior to cutting operations. Moreover, in prior art mechanisms, such repositioning may only take place when the front-end loader is positioned at or near grade level. A need, therefore, remains to allow for repositioning without the need for the operator of the primary driver to leave his or her seat, and without the need to lower the front-end loader to a height at or near grade level.

### BRIEF DESCRIPTION OF FIGURES

FIG. 1 depicts an overview of the preferred embodiment of the invention, utilized in association with its raised overhead level operating position in conjunction with a primary driver.

FIG. 2. depicts a perspective view of an embodiment of the invention as utilized in a preferred method of use with its cutter deck positioned at the operating position parallel to the ground at grade level.

FIG. 3 depicts an embodiment of the invention deployed in a semi-raised operating position in conjunction with a primary driver.

FIG. 4 depicts a top down of the cutter deck in an embodiment of the invention.

FIG. 5 depicts a linkage system and pivot points for the unique linkage design in an embodiment of the invention.

FIG. 6 depicts a quick attach plate in an embodiment of the invention.

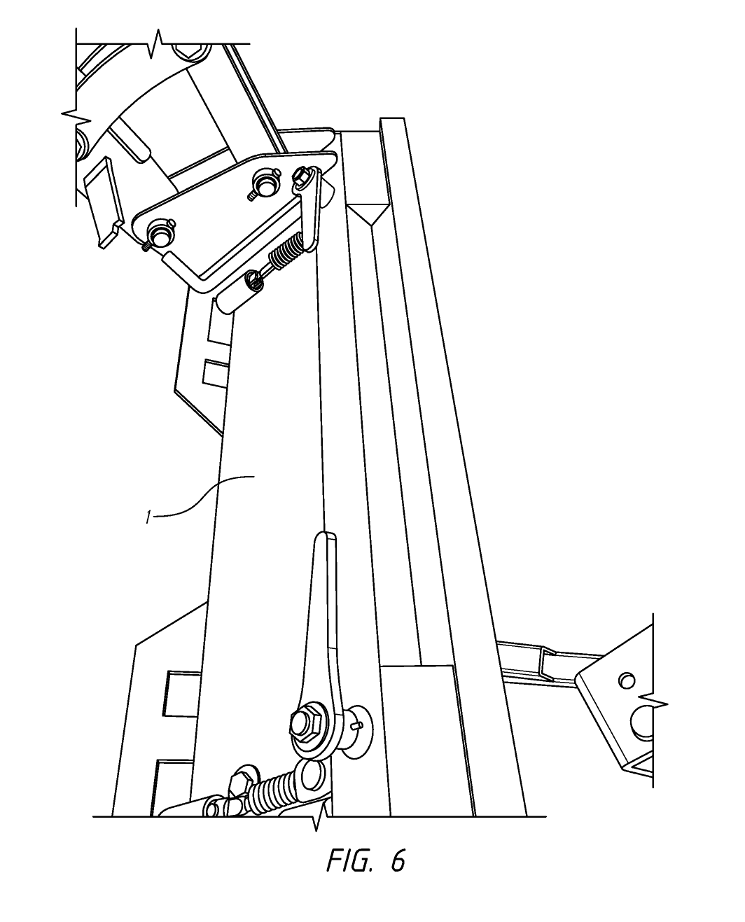

FIG. 7 depicts the attachment of a primary driver to a cutter deck via universal quick attach plate with a plurality of hydraulic hoses in an embodiment of the invention.

FIG. 8 depicts an alternative view of the attachment of a primary driver to a cutter deck via universal quick attach plate with a plurality of hydraulic hoses in an embodiment of the invention.

FIG. 9 depicts the connections of hydraulic hoses relative to other components in an embodiment of the invention.

FIG. 10 depicts a bottom up view of the cutter deck in an embodiment of the invention.

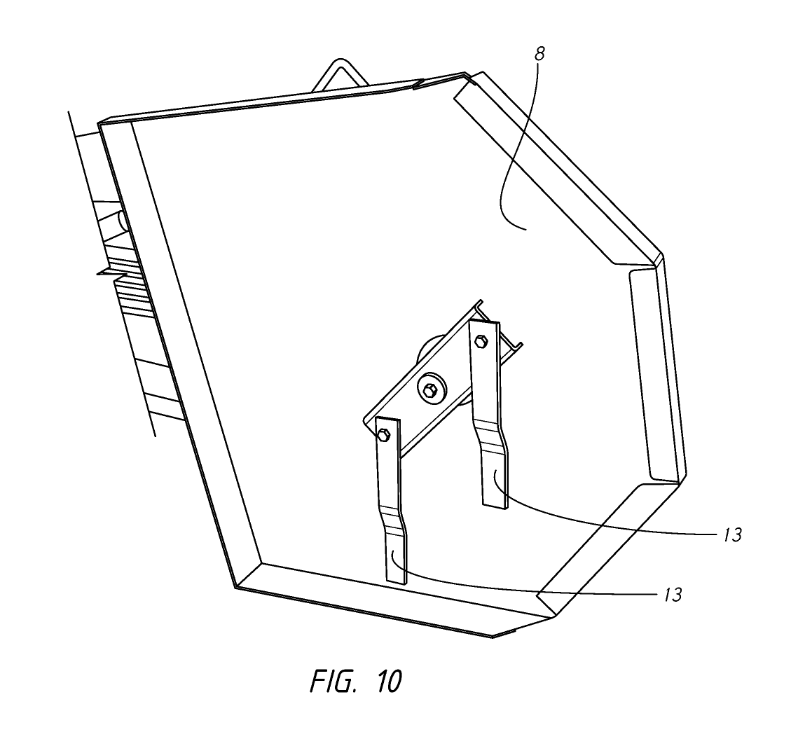

### SUMMARY OF THE INVENTION

The preferred embodiment of the present invention is generally described as an articulable and raiseable brush cutting implement. In various embodiments, the term “brush” can be utilized interchangeably with “vegetation.” Generally, the inventor intends for the articulable and raiseable brush cutting implement to function in association with a hydraulic-driven brush cutter system. In embodiments, the articulable and raiseable brush cutting implement may interact with material to cut above upon being raised or below upon being lowered by an operator of an attached primary driver 201.

### DETAILED DESCRIPTION

In an embodiment of the invention, the hydraulic-driven brush cutter system is operated by one person in association with the utilization of a primary driver 201. In an embodiment, a primary driver 201 comprises a tractor. In an alternative embodiment, a primary driver 201 comprises a skid steer. In varying embodiments, the primary driver 201 comprises a John Deere Series 4 unit, a John Deere Series 5 unit, or a John Deere Series 6 unit. In varying embodiments, the primary driver 201 comprises a Kubota Series M unit, a Kubota Series Mx unit, or a Kubota Series L unit. In varying embodiments of the invention, the primary driver 201 comprises a Mahindra Series 5500 unit, a Mahindra Series 6000 unit, a Mahindra Series “mPower” unit, a Mahindra Series “mForce” unit, a Mahindra M105 unit, or a Mahindra Series 9000 unit. In an embodiment, the primary driver 201 comprises a New Holland Series T unit. In varying embodiments, the primary driver 201 comprises a Massey Ferguson Series 2600, 46000, 4700, 5600, 6600, or 6700 unit. In varying embodiments, the primary driver 201 incorporates a quick attach plate 1 as recognized by one skilled in the art. In varying embodiments, the quick attach plate comprises a Quick Tach system utilized on “Bobcat”-type skid steer units, familiar to one skilled in the art, and most tractors manufactured by manufacturers well-known in the industry. In embodiments of the invention, an adapter blank plate, as known by one skilled in the art, is utilized or modified to facilitate the quick attachment of the hydraulic-driven brush cutter system to an otherwise incompatible quick attach plate. A non-exhaustive list of examples of a quick attach plate 1 are described in U.S. Pat. Nos. 6,725,584, 3,705,656, and 3,528,585, which are incorporated herein in their entirety.

The present inventor has recognized an advantage of an embodiment of the present invention in that it is simple to attach and detach from the primary driver 201. In an embodiment, the articulable and raiseable brush cutting implement is simple to attach and detach from the primary driver 201 by one person acting alone. Further, an embodiment of the articulable and raiseable brush cutting implement does not require the full dedication of a primary driver 201, but rather allows the articulable and raiseable brush cutting implement to serve merely as an attachment to a primary driver 201.

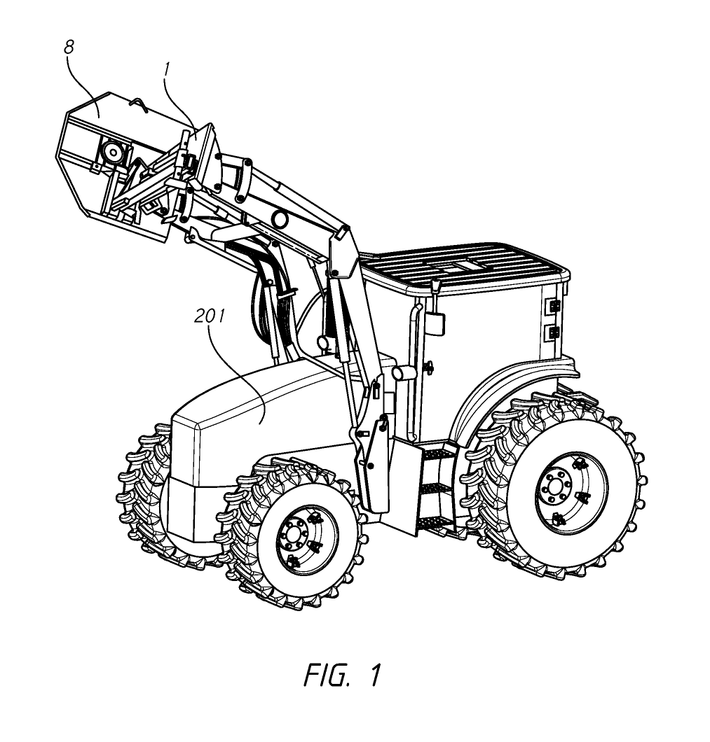

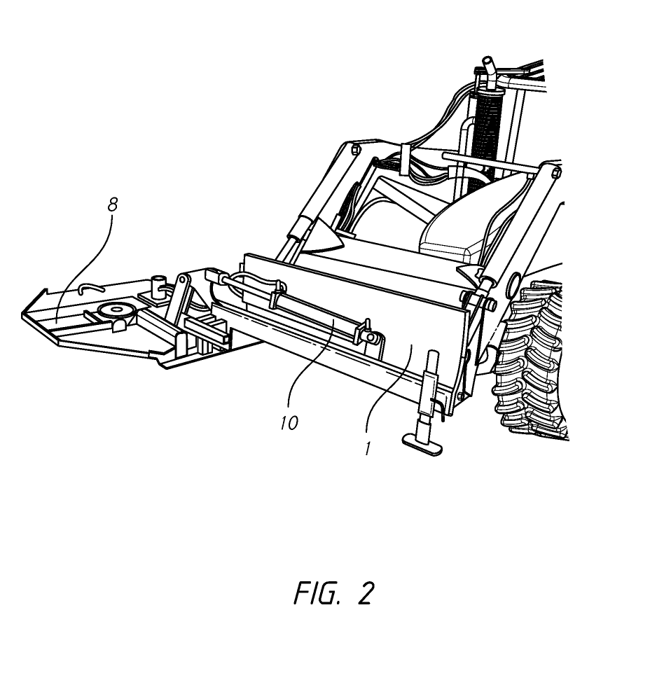

An embodiment of the invention incorporates a cutter deck 8, as depicted in FIG. 2. A cutter deck 8 in an embodiment of the invention is described as an attachable primary driver 201 implement that mounts to the front-end loader of the primary driver 201. A cutter deck 8 in an embodiment of the invention is also described as movably positionable in multiple dimensions, including in the height dimension. In the preferred embodiment of the invention, the cutter deck 8 is movably positionable to a height well above the height of the primary driver 201, as depicted in FIG. 1. The present inventor has recognized a specific advantage of this capability, specifically, that the cutter deck 8 may come into contact with vegetation at heights far above heights of previously known solutions. A cutter deck 8 in an embodiment of the invention, may be positioned above any vegetation above the trail such that the cutter deck 8 may face downward to cut the desired limbs. In varying embodiments, the rotational positioning of the cutter deck 8 is accomplished with the aid of a remote hydraulic connection. The remote hydraulic connection is linked to controls within the reach of the operator of the primary driver 201, which allows the operator to control a hydraulic cylinder 10 able to transfer force to the cutter deck 8. In an embodiment, the actuation of the hydraulic cylinder 10 orients the cutter deck 8 into a substantially upward facing, downward facing or side facing position.

In an embodiment, the cutter deck 8 is movable into various upwardly, sidewardly and downwardly facing orientation positions. In the preferred method of use, the operator will use the control levers of the primary driver 201 to articulate and raise the cutter deck 8 to the desired elevation level and the desired orientation angle. A unique aspect of the design of the preferred embodiment of the invention is its ability to position the cutter deck 8 to any angle from vertical to about 60 degrees below horizontal. Exemplary angles of the cutter deck 8 in an embodiment of the invention are depicted in FIGS. 1-3. In embodiments of the invention, the positioning of the cutter deck 8 to a variety of angles takes place at any position of the front-end loader of the primary driver 201, such that the height of the cutter deck 8, positioned in any desired angle, can exist at any point between grade level to the maximum height afforded by the highest available height of the particular front end loader design. Such height and positioning advantage in an embodiment is made possible utilizing the hydraulic cylinder and the unique linkage associated with the invention that allows the cutter deck 8 to affix to the quick attach plate 1. In embodiments of the invention, the control of the angulation of the cutter deck 8 and the height of the front-end loader is performed by the operator of the primary driver 201 in association with control mechanisms known by those skilled in the art affording the advantage to the operator of the system to control the system without leaving the control seat of the primary driver 201.

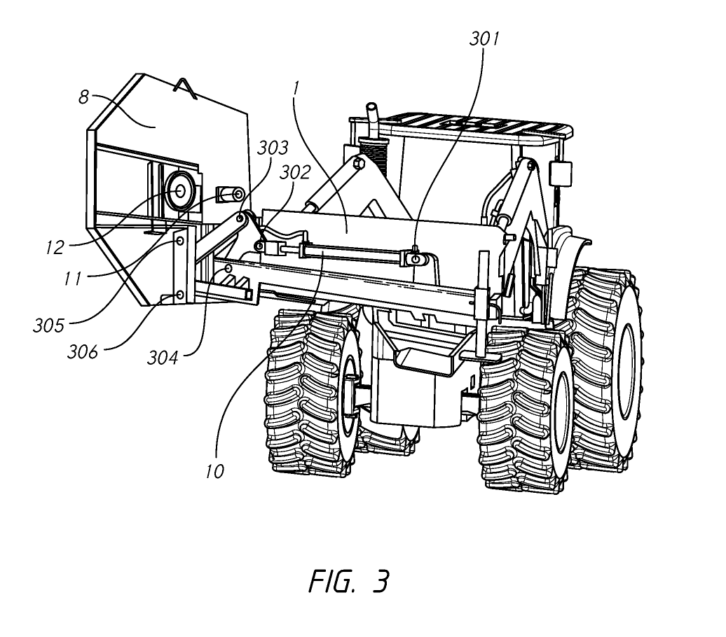

In a method of use as demonstrated in FIG. 3, the cutter deck 8 is articulated to an orientation generally perpendicular to the plane of the ground. In varying methods of use, the cutter deck 8 may be articulated in this angle of orientation, or any orientation angle from vertical to approximately 60 degrees below horizontal as desired by the operator. In an embodiment, the cutter deck 8 may simultaneously or thereafter be raised or lowered to varying heights, including heights above the operator's position, via repositioning of the front-end loader in association with control mechanisms generally present within known primary drivers. In an embodiment of the cutter deck as depicted in FIG. 1, the cutter deck 8 is positionable well above the height of the primary driver 201. The present inventor has recognized the advantage over prior art that in the embodiment of the invention configured as displayed in FIG. 1, the cutter deck 8 positioned at such height requires no counter-weight or other balancing mechanism to enable the embodiment of the invention to function.

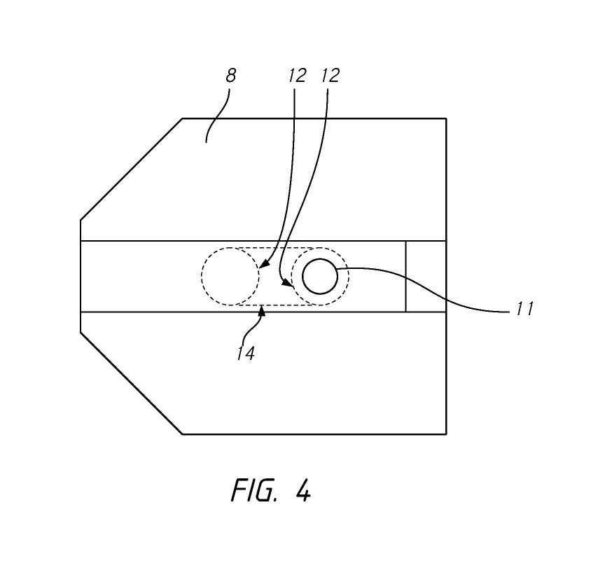

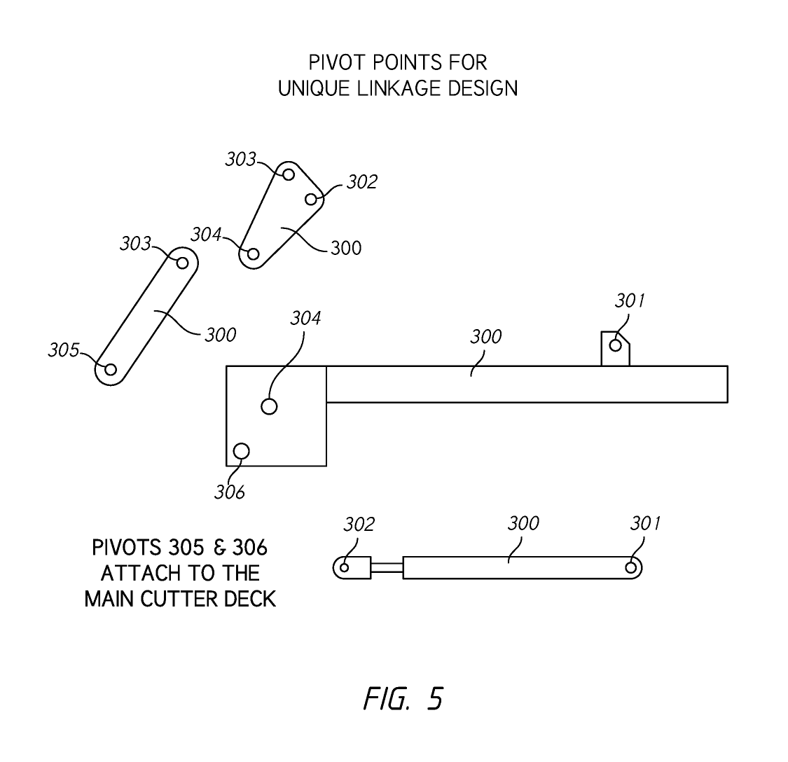

The preferred embodiment of the cutter deck 8 comprises the following dimensions: approximately 46 inches in width and 40 inches in depth, with a pulley drive system 12, pulley belt 14 and hydraulic motor 11 located near the center of the cutter deck 8 as depicted in FIG. 4. The preferred embodiment of the cutter deck 8 incorporates structural steel as the primary material in its composition. In the preferred method of use, the angle of the cutter deck 8 is adjustable, via force transferred via the hydraulic cylinder 10 and/or the linkage system 300 depicted in FIG. 5 mounted on the quick attach plate 1, from vertical to approximately 60 degrees below horizontal to cut brush located at grade level, above grade level, or below grade level. In an embodiment, the linkage system 300 that attaches the hydraulic cylinder 10 to the cutter deck is uniquely configured to enable the cutter deck 8 to be rotated from a position of vertical to approximately 60 degrees below horizontal while the hydraulic cylinder 10 maintains an almost horizontal position. The present inventor has recognized that such a configuration maintains the hydraulic cylinder 10 within the operating envelope of the quick attach plate 1, and resultantly reduces the length of hydraulic cylinder 10 required. Resultantly, the present inventor has recognized that such configuration reduces possibility of damage to the hydraulic cylinder 10 from limbs and other debris. The present inventor has recognized that a below level orientation allows the cutter deck 8 to address vegetation on ditch banks or within below grade crevasses. In an embodiment, the hydraulic cylinder 10 is positioned using the control lever on the primary driver 201 connected to the cutter deck 8 via the remote hydraulic connection. In an embodiment, the operator raises or lowers the cutter deck 8 as needed by moving the front-end loader of the primary driver 201.

In an embodiment, the present inventor has recognized that the articulable and raiseable brush cutting implement system incorporating the preferred configuration of the cutter deck 8 is able to cut vegetation above, aside and below the primary driver 201. In the preferred embodiment, the cutter deck 8 incorporates spinning cutter deck blades 13 able to cut trees, limbs, and brush, and other vegetation having a size of up to about two (2) inches in diameter.

The present inventor has recognized the advantage of the cutter deck 8 being located near the front of the primary driver 201, thereby making it easy for the operator to observe what the cutter deck blades 13 are cutting during operation. Resultantly, such embodiment presents the advantage of allowing the operator to make a rapid, unobstructed visual observation if the cutting operation was successful. In an embodiment, the elevation and angle of the cutter deck 8 are controllable by the operator of a primary driver 201 via the remote hydraulic control levers located within the primary driver 201 in reach of the operator during typical operation of the primary driver 201 by an operator, via methods, configurations and operations recognized by one skilled in the art. An embodiment of the invention incorporates the ability to mount the cutter deck 8 to the front-end loader of the primary driver 201. The present inventor has recognized that an advantage of such configuration is the ability to provide easy visibility of cutting during intended operations. The present inventor has recognized that such configuration provides ease of operation advantages and improves safety.

The present inventor has recognized advantages associated with easy attachment and removal of the articulable and raiseable brush cutting implement system to a primary driver 201. In particular, the present inventor has recognized that a key advantage of the preferred embodiment is that it only requires one person to attach or detach the cutter deck 8. The present inventor has also recognized that a key advantage of the preferred embodiment of the cutter deck 8 is that no tools or machinery are required to attach or detach the cutter deck 8 when utilized in conjunction with a quick attach plate 1 as recognized by one skilled in the art. An embodiment of the invention incorporates a quick attach plate 1, as recognized by one skilled in the art. An embodiment of the invention incorporates a quick attach plate-mounted hydraulic cylinder 10. A skid steer quick attach plate-mounted hydraulic cylinder 10 in an embodiment of the invention is configured with a linkage system 300 to allow the cutter deck 8 to be positioned at any angle from vertical to approximately 60 degrees below horizontal using the hydraulic system as the primary movement mechanism.

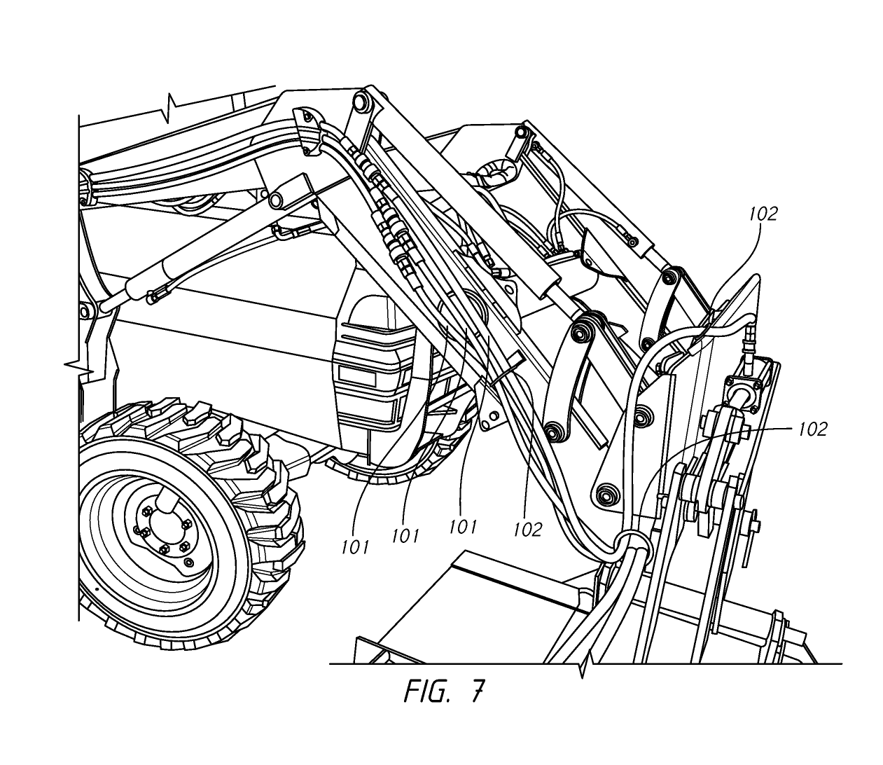

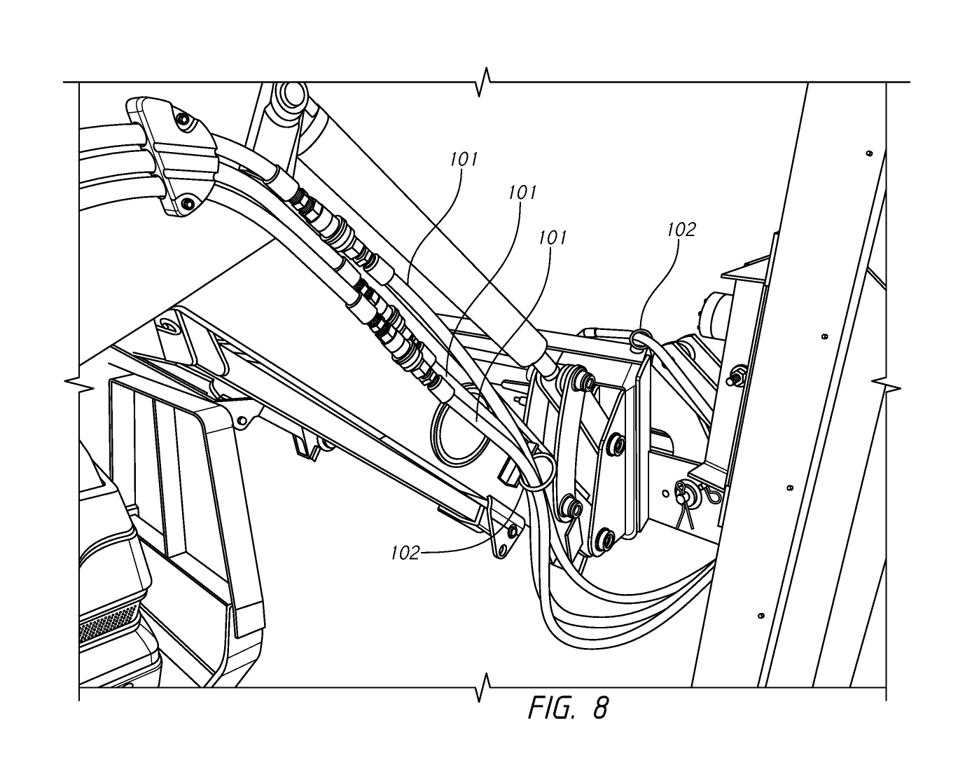

In the preferred embodiment, the cutter deck 8 is configured to rotate around the unique linkage system 300 depicted in FIG. 5. In the preferred embodiment, the linkage system 300 is configured as depicted in FIG. 5 and comprises steel as its primary material in composition. In the preferred embodiment, the linkage system 300 incorporates six pivot points 301-306 depicted in FIG. 5. The present inventor has recognized that such a linkage system 300 in an embodiment of the invention enables the cutter deck 8 to be positioned at any angle from vertical to about 60 degrees below horizontal by the operator of the primary driver 201 using the hydraulic system of the primary driver 201 and hydraulic system control mechanisms as known by one skilled in the art without leaving the seat of the primary driver 201. In an embodiment, the cutter deck 8 is attached at two specific pivot points, 305 and 306. In an embodiment, the quick attach plate 1 is attached at one pivot point. In an embodiment, each pivot point is configured to accommodate one inch steel pivot rods, hardened steel bushings and steel sleeve supports. An embodiment of the resulting assembly is depicted in FIGS. 7 and 8.

In an embodiment, as the hydraulic cylinder 10 orients into the retracted position, the cutter deck is oriented in the vertical position. In concert with commonplace hydraulic system control mechanisms such as control levers as known by one skilled in the art, as the operator of the primary driver 201 extends a hydraulic cylinder rod using the control lever in the primary driver 201 control seat, the linkage system 300 as configured in the preferred embodiment enables the cutter deck 8 to move from the vertical position to the desired angle position of the operator. In an embodiment, the lower angle limit is about 60 degrees below horizontal. In an exemplary known method of use, the cutter deck 8 can be returned to any angle position, including the vertical position, by the operator by retracting the hydraulic cylinder rod using the hydraulic control lever at the seat of the primary driver 201.

The present inventor has recognized that in the preferred embodiment of the invention, the hydraulic cylinder 10, configured such that it is attached to the quick attach plate 1, is provided with enough support and stability yet also enough proximity to the cutter deck 8 to properly function as intended. In an embodiment, the hydraulic cylinder 10 is configured with enough proximity and pathway clearance to allow for control by the operator via one or more hydraulic hoses 101. In the preferred embodiment, there are three hydraulic hoses 101. In an embodiment, the one or more hydraulic hoses 101 are attached to other structures via one or more hose ring guides 102, as depicted in FIG. 7. In an embodiment of the invention, the hose ring guides 102 capture and hold the one or more hydraulic hoses 101 on a path from the controls within reach of the operator to the hydraulic cylinder 10 in a fashion to ensure that the one or more hydraulic hoses do not unintendedly catch or rub any apparatus associated with the primary driver 201, the articulating and variable height vegetation cutter, or an external mass.

In the preferred method of attachment and removal of an embodiment of the cutter deck 8, the cutter deck 8 is attached and removed using the quick attach plate 1, via some or all of the following steps: 1. To attach the cutter deck 8, the operator should place two levers on the quick attach plate 1 on the primary driver 201 into the unlocked position; 2. the operator should then position the primary driver 201 in the necessary position to engage the cutter deck 8 to the quick attach plate 1; 3. the operator should raise the front end loader of the primary driver 201 until the quick attach plate 1 is engaged; 4. The operator should move the two levers on the quick attach plate 1 of the primary driver 201 in the locked position securing the cutter deck 8 to the primary driver 201.

In an embodiment of the invention, a hydraulic supply from the primary driver 201 is required for operation of the hydraulic motor 11 and hydraulic cylinder 10 in association with commonplace mechanisms understood by one skilled in the art. In an embodiment, the connections for the hydraulic supply, or remote hydraulic connection, from the primary driver 201 to the articulable and raiseable brush cutting system incorporate one or more hydraulic hoses 101. In an embodiment, the connections for the hydraulic supply from the primary driver 201 to the articulable and raiseable brush cutting system incorporate universal hydraulic quick attach fittings, as known by one skilled in the art. In varying embodiments of the invention, the location of the universal hydraulic quick attach fittings in relation to other components of the invention will depend upon the configuration of the primary driver 201 utilized in association with the invention.

In an embodiment of the invention, the present inventor has recognized the advantage that if the primary driver 201 has a rear implement connection, such as a conventional rotary cutter. In an embodiment such rear implement may be used simultaneously with cutter deck 8. The present inventor has recognized the advantage in the preferred embodiment that a rear implement may have the ability to further mulch any debris previously cut by the cutter deck 8. Examples of such a rear implement are described in U.S. Pat. Nos. 5,626,007, 7,784,255 and 4,865,132, which are incorporated by reference herein in their entirety.

An embodiment of the invention incorporates one or more cutter deck blades 13. Cutter deck blades 13 in an embodiment of the invention are operated via activation by the operator of the remote hydraulic connection that supplies hydraulic fluid to the hydraulic motor 11 located on the cutter deck 8. In an embodiment, cutter deck blades 13 operate in a fashion similarly to blades in stationary and non-articulable cutter decks, such as those described U.S. Pat. No. 5,626,007, incorporated by reference herein in its entirety. In the preferred method of use, the operator activates the cutter deck blades 13 by moving a control lever on the primary driver 201 to activate the remote hydraulic connection that supplies hydraulic fluid to the hydraulic motor 11 located on the cutter deck 8. The RPM of the cutter deck blades 13 in an embodiment of the invention is determined by the engine RPM of the primary driver 201 in association with mechanisms readily apparent by one skilled in the art. The present inventor has recognized that during the preferred method of use, the primary driver 201 RPM should be at a minimum when the control lever is engaged and gradually increased to between 2000 to 2500 RPM. The present inventor has recognized that in an embodiment, an RPM range of 2000 to 2500 RPM is sufficient to drive the cutter deck blades 13 to effectively perform. Cutter deck blades 13 in an embodiment of the invention are partially enclosed by the cutter deck 8 to minimize any cut items from traveling in an unintended direction. In an embodiment, the torque required to rotate the cutter deck blades 13 is transferred from the hydraulic motor 11 to the cutter deck blades 13 by a pulley drive system 12. In an embodiment, the pulley drive system 12 incorporates a pulley mounted to an output shaft of the hydraulic motor 11, and a pulley mounted to the input shaft of the cutter deck blades 13, as depicted in FIG. 4. In an embodiment, the pulleys are connected by a V-Belt 14, as known by one skilled in the art. In an embodiment, the cutter deck blades 13 operate in a similar fashion to other rotating cutter blades as well known to those skilled in the art.

The present inventor has recognized that in an embodiment, the pulley drive system 12 incorporates a slip clutch. In the embodiment, the slip clutch functions as a slip clutch as generally recognized by one skilled in the art. When incorporated, a slip clutch functions to mitigate risks in the event that any of the cutter deck blades 13 hits an object that is too large to cut. In an embodiment, a group of cutter deck blades 13 is intended to be engaged using the control lever on the primary driver 201 that activates the remote hydraulic connection supplying hydraulic fluid to the motor. In an embodiment, the return hose from the motor connects to the hydraulic fluid reservoir on the primary driver 201.

An embodiment of the invention incorporates a universal quick attach plate 1, as known by one skilled in the art. The preferred embodiment of the quick attach plate 1 comprises the following dimensions: 45 inches wide and 18 inches high. The preferred embodiment of the quick attach plate 1, incorporates structural steel in its composition. Embodiments of the invention are modified to coordinate with any quick attach plate to work in accord with the manufacture specifications of the primary driver 201.

An embodiment of the invention incorporates a hydraulic motor 11 and pulley drive system 12. A hydraulic motor 11 and pulley drive system 12 in an embodiment of the invention working together transfer the force necessary to provide the operator with the ability to operate the hydraulic motor 11 from the primary mover's hydraulic system. In an embodiment of the invention, the V-belt 14 and pulley drive system 12 acts as a slip clutch device, as recognized by one skilled in the art. The present inventor has recognized that the slip clutch device provides the advantage of being available for utilization when needed to prevent damage to the cutter deck blades 13 and/or the hydraulic motor 11.

An embodiment of the invention incorporates a control system providing the operator of the primary driver 201 with the ability to operate the hydraulic motor 11 and pulley drive system 12 without leaving the control seat of the primary driver 201 in accordance with methods and mechanisms recognized by one skilled in the art.

An embodiment of the invention incorporates the ability to position the cutter deck 8 at any angle position between a vertical orientation and about 60 degrees below horizontal relative to the horizon. In an embodiment, the articulation of the cutter deck 8 into any angle position is able to be accomplished at any elevation level of the front-end loader of the primary driver 201. In an embodiment, such positioning ability is provided by the hydraulic cylinder 10 and linkage system 300 and hydraulic hose connections to the primary driver 201.

An embodiment of the invention incorporates the ability to operate the cutter deck 8 at any elevation within the operating range of the front-end loader of the primary driver 201. An embodiment of the invention is accompanied by the advantage of easy access to the blade carrier to replace or sharpen the cutter deck blades 13.

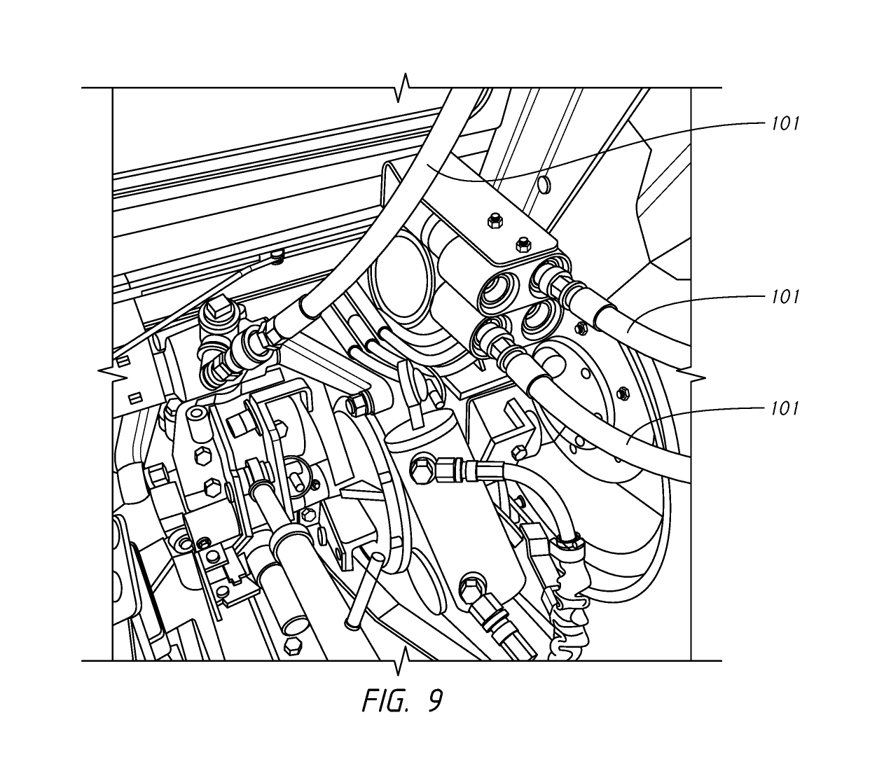

An embodiment of the invention incorporates a hydraulic motor 11. The hydraulic motor 11 in an embodiment of the invention is specifically affixed to the cutter deck 8 to power the cutter deck blades 13 via a pulley drive system. The hydraulic motor 11 in an alternative embodiment of the invention is mounted to the cutter deck 8 either aft or forward of the pulley drive system. A hydraulic motor 11 in an embodiment of the invention is also described as driven by the hydraulic pump of the primary driver 201, in accordance with mechanisms readily known by one skilled in the art. In an embodiment, the hydraulic motor 11 affixed to the cutter deck 8 is connected to the primary driver 201 hydraulic system using one or more hydraulic hoses 101 connected to the remote hydraulic connections. The length of hose and type of connection is determined by the configuration of the primary driver 201 and the location of the remote connections. In various embodiment of the inventions, one or more hydraulic hose guides 102 are utilized to ensure that the hydraulic hoses follow a specific pathway. In embodiments, such pathway is configured with the assistance of the hydraulic hose guides 102 to ensure that the hydraulic hoses 101 do not snag or interfere with other components of the primary driver or associated inventive components, or external masses. Embodiments of the invention incorporating three hydraulic hoses 101 connected to remote hydraulic connections are depicted in FIGS. 7, 8 and 9.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art. The terms “coupled” and “linked” as used herein is defined as connected, although not necessarily directly and not necessarily mechanically. A device or structure that is “configured” in a certain way is configured in at least that way, but may also be configured in ways that are not listed. Also, the sequence of steps in a flow diagram or elements in the claims, even when preceded by a letter does not imply or require that sequence.

1. A cutting system for attachment to a primary driver controlled by an operator, comprising:
A cutter deck articulable to varying orientation angles;
At least one cutter deck blade;
A hydraulic cylinder;
A hydraulic motor;
A hydraulic connection between the hydraulic cylinder, the hydraulic motor and the primary driver.

2. The system of claim 1, the cutter deck positionable to varying heights.

3. The system of claim 2, the varying heights corresponding to the elevation of an affixed front end loader of the primary driver.

4. The system of claim 1, further comprising a linkage system.

5. The system of claim 1, wherein the hydraulic cylinder is affixed to the cutter deck.

6. The system of claim 1, further comprising a pulley drive system.

7. The system of claim 1, further comprising one or more hydraulic hoses.

8. The system of claim 1, the cutter deck affixed to the primary driver via a quick attach plate.

9. The system of claim 1, further comprising a slip clutch.
